(19) United States
(12) Patent Application Publication
(10) Pub. No.: US 2015/0318886 A1
(43) Pub. Date: Nov. 5, 2015

(54) Voice Agent

(71) Applicants: Yen-Wei Hsu, Taipei (TW); Whei Chyou Wu, Fremont, CA (US)

(72) Inventors: Yen-Wei Hsu, Taipei (TW); Whei Chyou Wu, Fremont, CA (US)

(21) Appl. No.: 14/267,922

(22) Filed: May 2, 2014

(51) Int. Cl. H04B 1/3827; H04M 1/60

(52) U.S. Cl. CPC H04B 1/3838; H04M 1/6066

(57) ABSTRACT

The invention relates to a mobile phone, and more particularly, a mobile phone with less RF radiation.

### BACKGROUND OF THE INVENTION

1. Field of Invention

The invention relates to a mobile phone, and more particularly, a mobile phone with less RF radiation.

2. Description of Related Art

Mobile phone including smartphone is more and more welcome by people in nowadays. A mobile phone needs to power up to RF-wirelessly emit an electronic signal converted by a voice input into the smartphone to a remote destination such as mobile phone base station or internet. The RF(radio frequency) radiation emitted by the power can be high enough to hurt user's head if the mobile phone is brought close to user's ear to perform a phone talk. RF radiation is a kind of energy which can potentially damage to body especially brain with smartphone close to ear. Researchers have found that high and long-time exposure to RF radiations can potentially cause brain tumor and problems like headache, fatigue and difficulty in concentration.

One of the prior-art solutions to solve the problems is to use earphone or headphone that includes wired earphone and wireless earphone such as bluetooth earphone. Wireless earphone such as bluetooth earphone is designed for a short distance transmission with small power which is usually 1/800 of that of a typical smartphone. Using earphone still has drawbacks. (1) ear pain is one of the health hazards caused by prolonged use of earphone. Bluetooth headsets clipped in to ear's outer portion cause pain due to their weight. The uncomfortable sit of bluetooth headsets can also cause ear-pain. (2) ear is not designed to be inserted by anything, which is not natural. (3) hearing loss: higher earphone volume can cause hearing loss. (4) the RF radiation from a mobile phone still has chance to go through the conductive wire of wired earphone to reach to the brain. (5) bluetooth earphone is involved in sophisticated design, which is expensive.

Another way of the prior-art solutions to solve the problems is to use amplified speaker to let user keep a safe distance from the mobile phone when talking and listening. It has some drawbacks: (1) loud speaker will annoy the others around, (2) not every place is allowed to use loud speaker, (3) hard to listen when the environment is noisy, and (4) people like to protect personal privacy.

Based on the drawbacks, an inventive mobile phone with less RF radiation on a user when the user talking on the phone is revealed in the invention to solve the problems. A voice agent of the inventive mobile phone placed in a camera, a portable power bank, a tablet computer, a mobile phone such as a smartphone, and a wearable device such as watch or wristband are also respectively revealed in the invention. An internet, GSM and PSTN integration center based on the inventive mobile phone is also revealed in the invention.

An inventive camera, portable power bank, tablet computer, mobile phone such as smartphone, and wearable device such as watch or wristband respectively having the inventive voice agent of the inventive mobile phone are respectively revealed in the invention.

### BRIEF SUMMARY OF THE INVENTION

An inventive mobile phone with less RF radiation on a user when the user talking on the phone is revealed in the invention so user can bring the mobile phone close to ear to perform a safe phone talk.

An inventive mobile phone with its handset without telecom module used to interface with a remote mobile phone base station or internet is revealed in the invention.

A voice agent of the inventive mobile phone placed in a portable power bank is revealed in the invention.

A voice agent of the inventive mobile phone placed in a camera having at least one of picture taking capability and video shooting capability is revealed in the invention.

A voice agent of the inventive mobile phone placed in a tablet computer is revealed in the invention.

A voice agent of the inventive mobile phone placed in a mobile phone such as a smartphone is revealed in the invention.

A voice agent of the inventive mobile phone placed in a wearable device such as watch or wristband is revealed in the invention.

An internet, GSM and PSTN integration center based on the inventive mobile phone is revealed in the invention.

An inventive portable power bank having an inventive voice agent of the inventive mobile phone is revealed in the invention.

An inventive camera having an inventive voice agent of the inventive mobile phone is revealed in the invention.

An inventive tablet computer having an inventive voice agent of the inventive mobile phone is revealed in the invention.

An inventive wearable device having an inventive voice agent of the inventive mobile phone is revealed in the invention.

An inventive mobile phone such as a smartphone having an inventive voice agent of the inventive mobile phone is revealed in the invention.

### BRIEF DESCRIPTION OF THE SEVERAL VIEWS OF THE DRAWINGS

FIG. 1 has shown a first embodiment of an inventive mobile phone having a handset and a voice agent;

FIG. 2 has shown a second embodiment of an inventive mobile phone having a handset and a voice agent;

FIG. 3 has shown the inventive mobile phone in the first embodiment with its voice agent separably connected to its smartphone and the connection is separable;

FIG. 4 has shown the inventive mobile phone in the first embodiment with its voice agent contained in the housing of its smartphone and the voice agent can be taken out of the smartphone;

FIG. 5 has shown the inventive mobile phone in the first embodiment with its voice agent and smartphone respectively built with a connector;

FIG. 6 has shown the embodiment of the inventive mobile phone of FIG. 5 with its voice agent contained in the housing of its smartphone and the two connectors electrically connected.

FIG. 7 has shown the inventive mobile phone in the second embodiment with its voice agent separably connected to its smartphone and the connection is separable;

FIG. 8 has shown the inventive mobile phone in the second embodiment with its voice agent contained in the housing of its smartphone and the voice agent can be taken out of the smartphone;

FIG. 9 has shown the inventive mobile phone in the second embodiment with its voice agent and smartphone respectively built with a connector;

FIG. 10 has shown the embodiment of the inventive mobile phone of FIG. 10 with its voice agent contained in the housing of its smartphone and the two connectors electrically connected.

### DETAILED DESCRIPTION OF THE INVENTION

A smartphone, or smart phone, is a mobile phone with more advanced computing capability and connectivity than basic feature phones. Early smartphones typically combined the features of a mobile phone with those of another popular consumer device, such as a personal digital assistant (PDA), a media player, a digital camera, or a GPS navigation unit. Modern smartphones include all of those features plus the features of a touchscreen computer, including web browsing, WI-Fi, and 3rd-party apps. Currently, about 90% of handset sales worldwide are for devices powered by Google's Android and Apple's iOS mobile operating systems.

A mobile phone needs a certain power to RF-wirelessly emit a signal to a destination. The power consumed depends on emitting distance, for example, it takes less power for short distance emission and it takes bigger power for long distance emission.

A mobile phone needs to power up to a level to RF-wirelessly emit a signal to a remote destination such as a remote mobile phone base station or internet and the RF radiations excited by the power-up can be significantly large. When a user is talking on a mobile phone on-line with the mobile phone close to ear the RF radiations can be strong enough to hurt the user's head and the hurt gets worse for long-time exposure to the RF radiations. One of the main reasons for a user to bring a mobile phone closest to ear or head is when the user talks on the mobile phone at the same time the mobile phone is powered up to a level to RF-wireless emit an electronic signal converted by the user's voice input into the mobile phone to a remote mobile phone base station or internet. The way to solve the problem is by RF-wirelessly emitting the electronic signal to a nearby or local voice agent in a short-distance transmission and the voice agent RF-wirelessly emits the electronic signal to a remote mobile phone base station or internet.

The RF-wirelesss emission of the electronic signal by the voice agent to the remote mobile phone base station is a long-distance emission requiring larger power exciting larger RF radiation. The RF-wireless emission of the electronic signal by the mobile phone to the local voice agent is a short-distance or near-field emission requiring relatively low power exciting relatively low RF radiation so that when the voice agent is separated from the mobile phone and kept a safer distance from the user's head or body the mobile phone can be brought close to ear to perform a safe conversation. Briefly, when a user talks on the mobile phone on line (either on a phone call or internet) only an electronic signal converted by the user's voice input into the mobile phone is required to go through the local voice agent then to a remote mobile phone base station or internet, or in more detail, when a user talks on the mobile phone on line (either on a phone call or internet) only an electronic signal converted by the user's voice input into the mobile phone is required to be RF-wirelessly emitted to the local voice agent which then RF-wirelessly emits the electronic signal to a remote mobile phone base station or internet. The concept has revealed two inventive mobile phones respectively revealed in a first embodiment and a second embodiment.

It has been well known that the electronic signal in the RF-wireless emission is modulated so that the handset 11 can be brought close to ear with the voice agent 12 kept a safe distance from user's head to perform a safe talk.

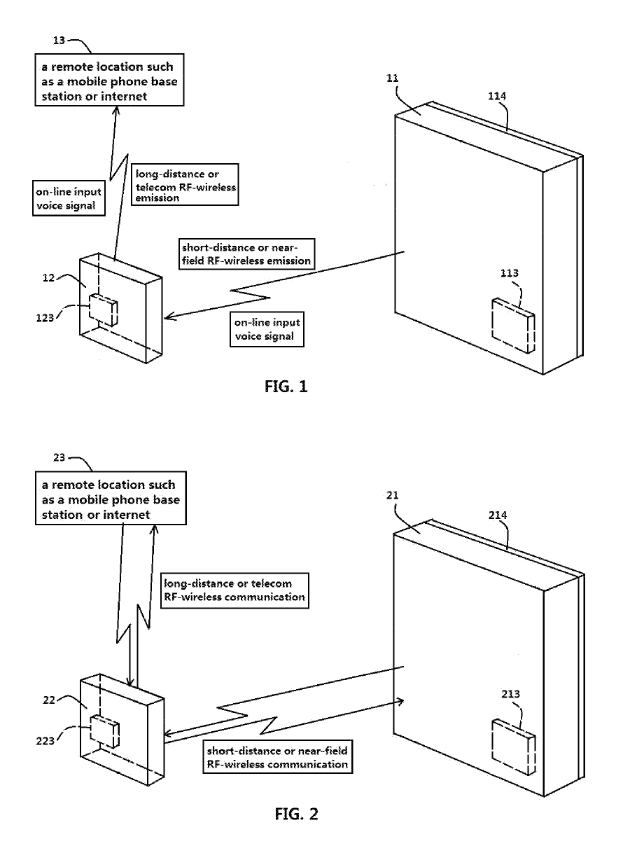

A first embodiment of an inventive mobile phone is shown in FIG. 1. FIG. 1 has shown an inventive mobile phone comprises a handset 11 having RF-wireless communication capability to RF-wirelessly communicate with a remote mobile phone base station or internet, a touchscreen 114 supporting multi-touch and a first battery 113 providing electrical power to the handset 11 and a local voice agent 12 having RF-wireless communication capability to RF-wirelessly communicate with the handset 11 and a remote mobile phone base station or internet and a second battery 123 providing electrical power to the voice agent 12. The “local” of the local voice agent 12 expresses the voice agent can be kept in a short distance from the handset 11.

When a user is talking on the handset 11 on line (either on a phone call or internet), electronic signals converted by the user's voice input into the handset 11 are required to go through the local voice agent 12 then to a remote mobile phone base station or internet 13, or in more detail, when a user talks on the handset 11 online (either on a phone call or internet) electronic signals converted by the user's voice input into the handset 11 are required to be RF-wirelessly emitted to the local voice agent 12 which then RF-wirelessly emits the electronic signal to a remote mobile phone base station or internet 13 as shown in FIG. 1. The electronic signals will be modulated in the RF-wireless emission and the modulation method to the electronic signal will not be discussed here. For convenience, the electronic signals converted by voice of a user input into a mobile phone on line can also be called “on-line input voice signals” in the present invention.

Both the RF-wireless communication between the voice agent 12 and the remote mobile phone base station 13 and the RF-wireless communication between the handset 11 and the remote mobile phone base station 13 are long-distance communications respectively requiring higher power exciting relatively larger RF radiation. The relatively larger RF radiation can cause more potential hurt to brain if the RF radiation is close to head, for example, if the handset 11 with the voice agent 12 fixed to or contained in the handset 11 is close to ear the RF radiation can potentially hurt brain.

The RF-wireless emission of the “on-line input voice signals” by the handset 11 to the local voice agent 12 is a short-distance or near-field RF-wireless emission requiring only relatively small power exciting small RF radiation so that the handset 11 can be brought close to user's ear with the voice agent 12 kept a safe distance from user's head to perform a safe talk, in other words, when the voice agent 12 is separated from the handset 11 and kept a safe distance from the user's head the handset 11 can be brought close to ear to perform a safe talk.

The prior-art mobile phone RF-wirelessly emits an “on-line input voice signal” directly to the remote mobile phone base station or internet producing considerate RF radiations which can be strong enough to hurt user's brain when the mobile phone is brought close to ear.

The RF-wireless communication between the handset 11 and the voice agent 12 is not limited to any particular wireless technology standard, for example, an embodiment, the wireless technology standard can be bluetooth, NFC (near-field communication) or IEEE 802.11, IEEE 802.15. 4, RF4CE or ZigBee. For convenience, the wireless technology standard can also be called “near-field standard”. The voice agent 12 can have more than one near-field standards capable of communicating with devices having different near-field standards.

The RF-wireless communication between a remote mobile phone base station 13 or internet 13 and the handset 11 and the RF-wireless communication between a remote mobile phone base station 13 or internet 13 and the voice agent 12 are respectively not limited to any particular wireless technology standard, for example, an embodiment, the wireless technology standard can be 2G, GSM (global system for mobile communication), 3G, 4G, LTE, Wimax or Wi-Fi standard. For convenience, the wireless technology standard can also be called “telecom standard” in the invention. The handset 11 can have more than one telecom standards capable of communicating with different telecom standards of a remote mobile phone base station 13 or internet 13. The voice agent 12 can have more than one telecom standards capable of communicating with different telecom standards of a remote mobile phone base station 13 or internet 13.

The handset 11 of the inventive mobile phone revealed in the first embodiment of FIG. 1 is not limited to any particular handset, for example, the handset 11 of the inventive mobile phone revealed in the second embodiment of FIG. 1 can be a smartphone or a remote controller to control a television.

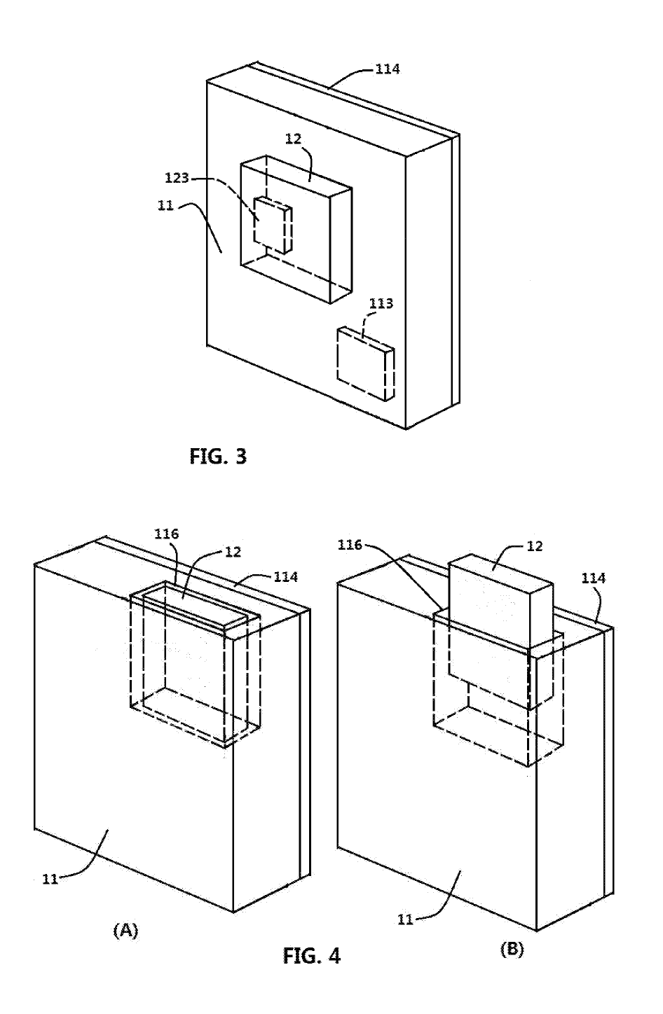

The voice agent 12 can be connected to the handset 11 for easy carrying and the connection is separable as an embodiment shown in FIG. 3 because when the handset 11 with the voice agent 12 connected to it brought close to ear the RF radiation by the voice agent 12 is close to ear and head causing possible hurt.

The voice agent 12 can be contained in a space 166 formed in the housing of the handset 11 for easy carrying and a cap (not shown in the drawing) can cover the space 116 to fully hide the voice agent 12 inside the housing of the handset 11 and the voice agent 12 can be taken out of the housing of the handset 11 to bring the handset 11 close to ear for performing a phone call as an embodiment shown in FIG. 4, FIG. 4(A) has shown the voice agent 12 is contained in the housing of the handset 11 and FIG. 4(B) has shown the voice agent 12 can be taken out of the housing of the handset 11.

The voice agent 12 can be placed at anywhere in the house, in the office, on a desk nearing the user, or contained in the user's portable purse, pocket or handbag within a distance range from the handset 11 allowable by its associated near-field standard.

An embodiment, the voice agent 12 can also be powered by the grid-power in the house, office or school.

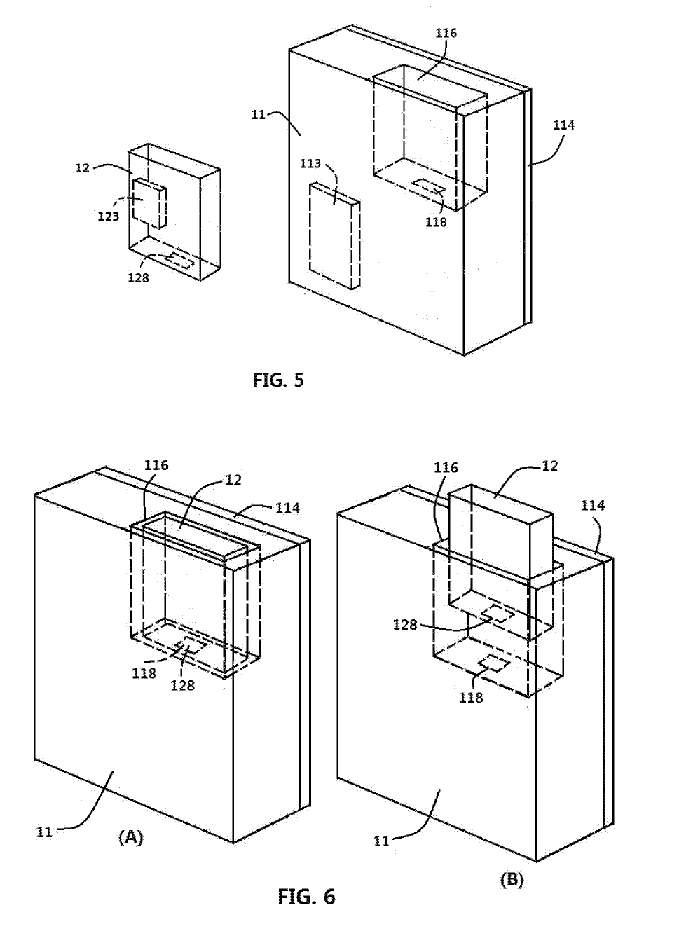

FIG. 5 has shown the handset 11 and the voice agent 12 can respectively further comprise a first connector 118 and a second connector 128. The voice agent 12 can be contained in the handset 11 to also electrically connect the first connector 118 and the second connector 128 as shown in an embodiment of FIG. 6 advantages in that the handset 11 and the voice agent 12 can be in electrically wired communication by the electrical connection between the first connector 118 and the second connector 128 and the RF-wireless communication between the handset 11 and the voice agent 12 can be disabled by the electrical connection between the first connector 118 and the second connector 128. When the first connector 118 and the second connector 128 are electrically separated the RF-wireless communication between the handset 11 and the voice agent 12 is restored by the electrical separation between the first connector 118 and the second connector 128. And, further, when the first battery 113 is electrically charged the second battery 123 can be electrically charged at the same time by the electrical connection between the first connector 118 and the second connector 128.

SIM card of the inventive mobile phone can be disposed at the voice agent 12 or the handset 11 of the inventive mobile phone revealed in the first embodiment of FIG. 1.

An embodiment, the voice agent 12 of the inventive mobile phone revealed in the first embodiment of FIG. 1 can be wiredly or wirelessly connected to public switched telephone network (PSTN) so that PSTN and the voice agent 12 can be wiredly or RF-wirelessly communicate with each other, for example, the voice agent 12 can communicate with call from indoor home line functioning as a wireless home phone. The voice agent 12 is capable of communicating with internet, GSM and PSTN and the voice agent 12 is also capable of communicating local devices as tablet computer, notebook, destop computer, remote controller, smartphones or television through near-field communication such as bluetooth, NFC, IEEE 802.15. 4, RF4CE or ZigBee so that the voice agent 12 can be viewed as an internet, GSM and PSTN integration center. The local devices as listed above can exchange information with each other through the voice agent 12, for example, email, message from GSM, information about the phone number and the caller from PSTN, and video and audio from internet can be display on television. For another advantage, it's well known that computer can communicate with internet but can not directly communicate with GSM system, with the voice agent 12 computer can communicate with GSM system through the voice agent 12.

Portable power bank having a plurality of batteries is known to be used as a backup power to mobile phone and is more welcome in the market. An embodiment, the voice agent 12 of the inventive mobile phone revealed in the first embodiment of FIG. 1 can be placed inside a portable power bank and at least a battery inside the portable power bank may be the second battery 123 of the voice agent 12. Or, an another embodiment, an inventive portable power bank is revealed by having the voice agent 12 of the inventive mobile phone revealed in the first embodiment of FIG. 1 and at least a battery inside the portable power bank may be the second battery 123 of the voice agent 12. The portable power bank is not limited to any particular power bank, for example, the power bank can be a wiredly or wirelessly charged power bank.

Wearable device or computer known as watch or wristband advantage for portability and new technology. An embodiment, the voice agent 12 of the inventive mobile phone revealed in the first embodiment of FIG. 1 can be placed inside a wearable device or computer so that the short-distance RF-wireless capability and the long-distance RF-wireless capability of the voice agent 12 may provide the short-distance RF-wireless capability and the long-distance RF-wireless capability to the wearable device or computer and the battery of the wearable device or computer may be the second battery 123 of the voice agent 12. Or, another embodiment, an inventive wearable device or computer is revealed to have the voice agent 12 of the inventive mobile phone revealed in the first embodiment of FIG. 1 and the battery of the wearable device or computer may be the second battery 123 of the voice agent 12.

Camera with picture taking and video shooting capabilities is well known to be equipped with short-distance RF-wireless communication capability such as bluetooth to communicate with other local bluetooth devices such as smartphone and long-distance RF-wireless communication capability to connect to the mobile phone base station or internet to upload pictures and videos. An embodiment, the voice agent 12 of the inventive mobile phone revealed in the first embodiment of FIG. 1 can be placed inside a camera having at least one of the picture taking and video shooting capabilities so that the short-distance RF-wireless capability and the long-distance RF-wireless capability of the voice agent 12 may provide the short-distance RF-wireless capability and the long-distance RF-wireless capability to the camera and the battery of the camera may be the second battery 123 of the voice agent 12. Or, another embodiment, an inventive camera is revealed to have the voice agent 12 of the inventive mobile phone revealed in the first embodiment of FIG. 1 and the battery of the camera may be the second battery 123 of the voice agent 12.

Portable tablet computer known as Apple's ipad is well known to be equipped with short-distance RF-wireless communication capability such as bluetooth to communicate with other local bluetooth devices and long-distance RF-wireless communication capability to connect to the mobile phone base station of internet. An embodiment, the voice agent 12 of the inventive mobile phone revealed in the first embodiment of FIG. 1 can be placed inside a tablet computer so that the short-distance RF-wireless capability and the long-distance RF-wireless capability of the voice agent 12 may provide the short-distance RF-wireless capability and the long-distance RF-wireless capability to the tablet computer and the battery of the tablet computer may be the second battery 123 of the voice agent 12. Or, another embodiment, an inventive tablet computer is revealed to have the voice agent 12 of the inventive mobile phone revealed in the first embodiment of FIG. 1 and the battery of the tablet computer may be the second battery 123 of the voice agent 12.

A mobile phone such as smartphone is well known to be equipped with short-distance RF-wireless communication capability such as bluetooth to communicate with other local bluetooth devices and long-distance RF-wireless communication capability to connect to the mobile phone base station or internet. An embodiment, the voice agent 12 of the inventive mobile phone revealed in the first embodiment of FIG. 1 can be placed inside a smartphone so that the short-distance RF-wireless capability and the long-distance RF-wireless capability of the voice agent 12 may provide the short-distance RF-wireless capability and the long-distance RF-wireless capability to the smartphone and the battery of the smartphone may be the second battery 123 of the voice agent 12. Or, another embodiment, an inventive mobile phone is revealed to have the voice agent 12 of the inventive mobile phone revealed in the first embodiment of FIG. 1 and the battery of the smartphone may be the second battery 123 of the voice agent 12. Many people are seen to carry more than one mobile phone. One of them can have the voice agent 12 of the inventive mobile phone revealed in the first embodiment of FIG. 1.

The voice agent 12 of the inventive mobile phone revealed in the first embodiment of FIG. 1 can be wiredly or wirelessly connected to a television to provide short-distance RF-wireless capability and the long-distance RF-wireless capability to the television featuring all the information from remote mobile phone base station or Internet can be displayed on the television. The wiredly connection between the voice agent 12 and the television can be hot-swap. Or, an inventive television is revealed to have the voice agent 22 of the inventive mobile phone revealed in the second embodiment of FIG. 2.

A second embodiment of an inventive mobile phone is shown in FIG. 2. FIG. 2 has shown an inventive mobile phone comprises a handset 21 having RF-wireless communication capability, a touch-screen 214 supporting multi-touch and a first battery 213 providing electrical power to the handset 21 and a local voice agent 22 having RF-wireless communication capability to RF-wirelessly communicate with the handset 21 and a remote mobile phone base station or internet 23 and a second battery 223 providing electrical power to the voice agent 22. The handset 21 has no RF telecom module unable to RF-wireless communicate with a remote mobile phone base station or internet 23, in other words, The communication between the handset 21 and the remote mobile phone base station or internet has to go through the local voice agent 22. The voice agent 22 and a remote mobile phone base station or internet can RF-wirelessly communicate with each other and the voice agent 22 and the handset 21 can RF-wirelessly communicate with each other. The telecom module expresses to include all the needed softwares and the hardwares associated with RF-wireless communication with a remote mobile phone base station or internet.

The RF-wirelesss emission by the voice agent 22 to the remote mobile phone base station or internet 23 is a long-distance emission requiring larger power exciting larger RF radiation. The RF-wirelesss emission by the handset 21 to the voice agent 22 is a short-distance or near-field transmission requiring very small power exciting small RF radiation so that the handset 21 can be brought close to ear with the voice agent 22 kept a safe distance from user's head to perform a safe talk, in other words, when the voice agent 22 is separated from the handset 21 and kept a safe distance from the user's head the handset 21 can be brought close to ear to perform a safe talk.

The term “voice agent” 22 is still used in the second embodiment of the inventive mobile phone of FIG. 2 for highlighting it main function.

The RF-wireless communication between the handset 21 and the voice agent 22 is not limited to any particular wireless technology standard, for example, an embodiment, the wireless technology standard can be bluetooth, NFC (near-field communication) or IEEE 802.11, IEEE 802.15. 4, RF4CE or ZigBee. For convenience, the standard can also be called “near-field standard” in the invention. The voice agent 22 can have more than one near-field standards capable of communicating with devices respectively having different near-field standards.

The RF-wireless communication between the remote destination as a remote mobile phone base station 23 or internet 23 and the voice agent 22 is not limited to any particular wireless technology standard, for example, an embodiment, the wireless technology standard can be 2G, GSM, 3G, 4G, LTE, Wimax or Wi-Fi standard. For convenience, the standard can also be called “telecom standard” in the invention. The voice agent 22 can have more than one telecom standards capable of communicating with different telecom standards of a remote mobile phone base station 23 or internet 23.

SIM card of the inventive mobile phone revealed in the second embodiment of FIG. 2 can be disposed at the voice agent 22 or the handset 21.

RF telecom module has some features: (1) high frequency RF telecom module for long distance transmission capability usually requires a certain power level consuming more electrical power, (2) high frequency RF telecom module for long distance transmission capability usually requires a certain power level which can be a main source of heat and electromagnetic interference (or EMI) in mobile phone, (3) high frequency RF telecom module is involved in multiple wireless technology standards and sophisticated design, which is expensive, (4) the heat and EMI produced by the RF telecom module further deteriorates the stability of the high frequency RF circuit, which adds difficulty to the circuit design, (5) high frequency RF telecom module uses a lot of resources in mobile phone limiting the resources shared by the applications, (6) the software associated with RF telecom module is very complicated, and (7) a mobile phone having RF telecom module exciting RF radiations which can be strong enough to hurt head when the phone is brought close to ear to talk on the phone.

The handset 21 of the inventive mobile phone of the second embodiment of FIG. 2 without RF telecom module has some advantages: (1) the handset 21 only has short-distance RF-wireless circuit designed for short-distance emission requiring small power, which is easier to design, (2) heat and EMI problems become lowered without RF telecom module, which is helpful to the stability and the design of the circuit, (3) the handset 21 without RF telecom module can have longer time to be operated, (4) the handset 21 only has short-distance transmission requiring small power producing very small RF radiations so the handset 21 can be brought close to ear for a safer talk on line, (5) the resources of the handset 21 without RF telecom module can be released to more applications such as game and Apps and the demand on CPU will be lowered, and (6) RF telecom module is involved in sophisticated design, which is very expensive, a mobile phone without RF telecom module will become cheaper and the voice agent 22 of the inventive mobile phone can still be used with a new handset having no telecom module replacing an old handset, for example, the old handset is out of order or user likes to have a new style handset with less cost pressure.

The handset 21 of the inventive mobile phone revealed in the second embodiment of FIG. 2 is not limited to any particular handset, for example, the handset 21 of the inventive mobile phone revealed in the second embodiment of FIG. 2 can be a smartphone or a remote controller to control a television.

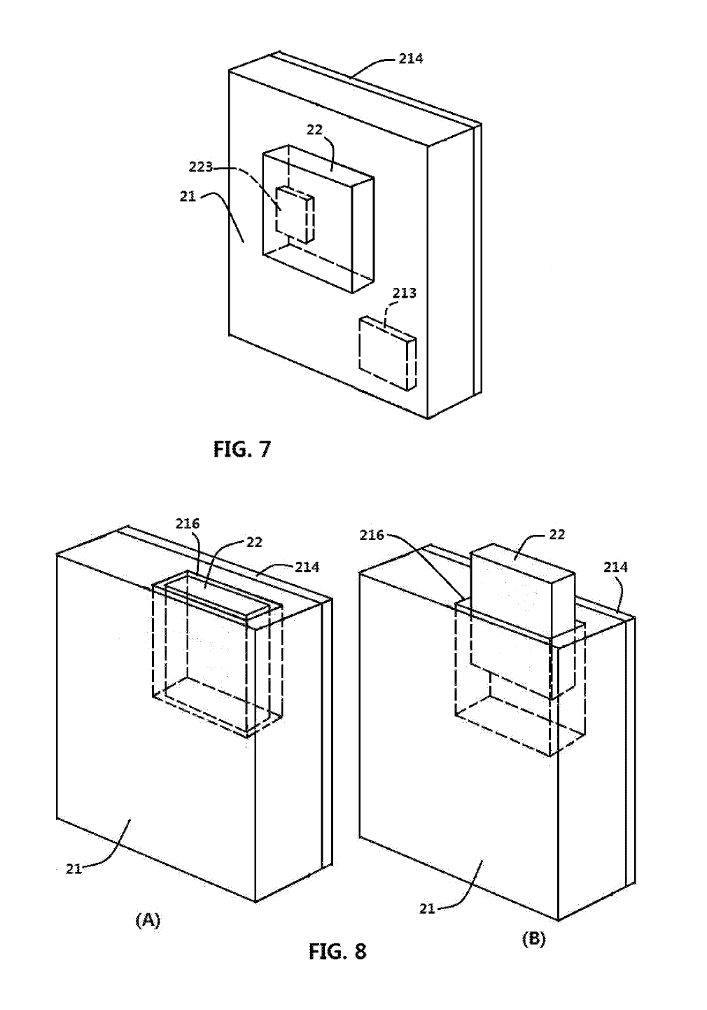

The voice agent 22 can be connected to the handset 21 for easy carrying and the connection is separable as an embodiment shown in FIG. 7 because when the handset 21 with the voice agent 22 connected to it brought close to ear the RF radiation by the voice agent 22 is close to ear and head causing possible hurt.

The voice agent 22 can be contained in a space 266 formed in the housing of the handset 21 for easy carrying and a cap (not shown in the drawing) can cover the space 216 to fully hide the voice agent 22 inside the housing of the handset 21 and the voice agent 22 can be taken out of the housing of the handset 21 to bring the handset 21 close to ear for performing a phone call as an embodiment shown in FIG. 8, FIG. 8(A) has shown the voice agent 22 is contained in the housing of the handset 21 and FIG. 8(B) has shown the voice agent 22 can be taken out of the housing of the handset 21.

The voice agent 22 can be placed at anywhere in the house, in the office, on a desk nearing the user, or contained in the user's portable purse, pocket or handbag within a distance range from the handset 21 allowable by its associated near-field standard.

An embodiment, the voice agent 22 can also be powered by the grid-power in the house, office or school.

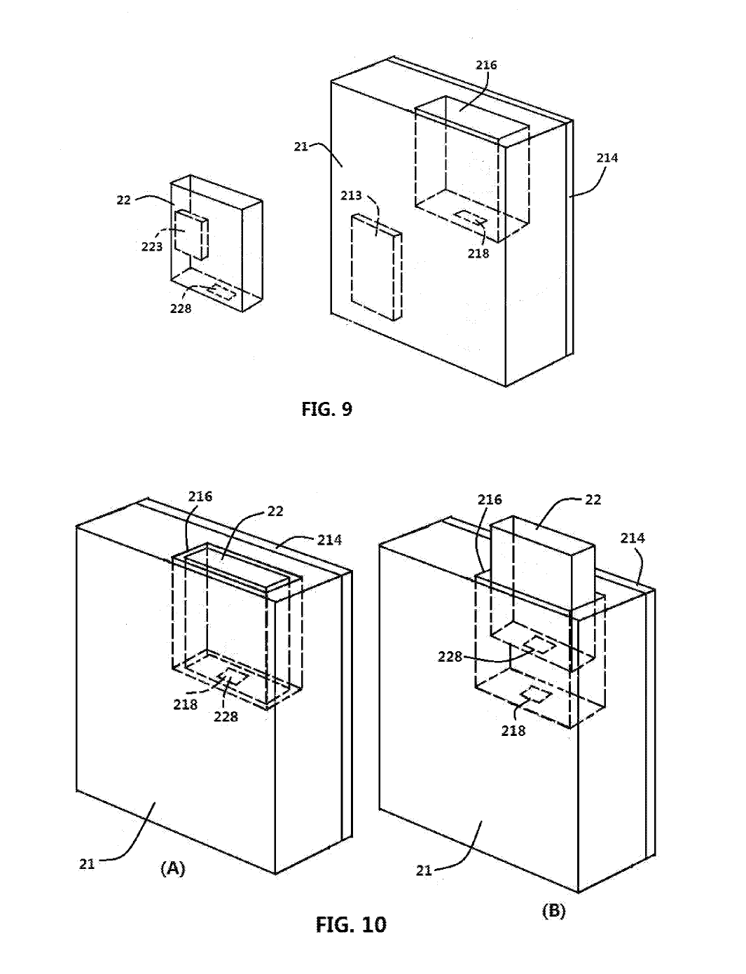

FIG. 9 has shown the handset 21 and the voice agent 22 can respectively further comprise a first connector 218 and a second connector 228. The voice agent 22 can be contained in the handset 21 to also electrically connect the first connector 218 and the second connector 228 as shown in an embodiment of FIG. 10 advantages in that the handset 21 and the voice agent 22 can be in electrically wired communication by the electrical connection between the first connector 218 and the second connector 228 and the RF-wireless communication between the handset 21 and the voice agent 22 can be disabled by the electrical connection between the first connector 218 and the second connector 228. When the first connector 218 and the second connector 228 are electrically separated the RF-wireless communication between the handset 21 and the voice agent 22 is restored by the electrical separation between the first connector 218 and the second connector 228. And, further, when the first battery 213 is electrically charged the second battery 223 can be electrically charged at the same time by the electrical connection between the first connector 218 and the second connector 228.

An embodiment, the voice agent 22 of the inventive mobile phone revealed in the second embodiment of FIG. 2 can be wiredly or wirelessly connected to public switched telephone network (PSTN) so that PSTN and the voice agent 22 can be wiredly or RF-wirelessly communicate with each other, for example, the voice agent 22 can communicate with call from indoor home line functioning as a wireless home phone. The voice agent 22 is capable of communicating with internet, GSM and PSTN and the voice agent 22 is also capable of communicating local devices as tablet computer, notebook, destop computer, smartphones, remote controller or television through near-field communication such as bluetooth, NFC, IEEE 802.15. 4, RF4CE or ZigBee so that the voice agent 22 can be viewed as an internet, GSM and PSTN integration center. The local devices as listed above can exchange information with each other through the voice agent 22, for example, email, message from GSM, information about the phone number and the caller from PSTN, and video and audio from internet can be display on television. For another advantage, it's well known that computer can communicate with internet but can not directly communicate with GSM system, with the voice agent 22 computer can communicate with GSM system through the voice agent 22.

Portable power bank having a plurality of batteries is known to be used as a backup power to mobile phone and is more welcome in the market. An embodiment, the voice agent 22 of the inventive mobile phone revealed in the second embodiment of FIG. 2 can be placed inside a portable power bank and at least a battery inside the portable power bank may be the second battery 223 of the voice agent 22. Or, an another embodiment, an inventive portable power bank is revealed by having the voice agent 22 of the inventive mobile phone revealed in the second embodiment of FIG. 2 and at least a battery inside the portable power bank may be the second battery 223 of the voice agent 22. The portable power bank is not limited to any particular power bank, for example, the power bank can be a wiredly or wirelessly charged power bank.

Wearable device or computer known as watch or wristband advantage for portability and new technology. An embodiment, the voice agent 22 of the inventive mobile phone revealed in the second embodiment of FIG. 2 can be placed inside a wearable device or computer so that the short-distance RF-wireless capability and the long-distance RF-wireless capability of the voice agent 22 may provide the short-distance RF-wireless capability and the long-distance RF-wireless capability to the wearable device or computer and the battery of the wearable device or computer may be the second battery 223 of the voice agent 22. Or, another embodiment, an inventive wearable device or computer is revealed to have the voice agent 22 of the inventive mobile phone revealed in the second embodiment of FIG. 2 and the battery of the wearable device or computer may be the second battery 223 of the voice agent 22.

Camera with picture taking and video shooting capabilities is well known to be equipped with short-distance RF-wireless communication capability such as bluetooth to communicate with other local bluetooth devices such as smartphone and long-distance RF-wireless communication capability to connect to the mobile phone base station or internet to upload pictures and videos. An embodiment, the voice agent 22 of the inventive mobile phone revealed in the second embodiment of FIG. 2 can be placed inside a camera having at least one of the picture taking and video shooting capabilities so that the short-distance RF-wireless capability and the long-distance RF-wireless capability of the voice agent 22 may provide the short-distance RF-wireless capability and the long-distance RF-wireless capability to the camera and the battery of the camera may be the second battery 223 of the voice agent 22. Or, another embodiment, an inventive camera is revealed to have the voice agent 22 of the inventive mobile phone revealed in the second embodiment of FIG. 2 and the battery of the camera may be the second battery 223 of the voice agent 22.

Portable tablet computer known as Apple's ipad is well known to be equipped with short-distance RF-wireless communication capability such as bluetooth to communicate with other local bluetooth devices and long-distance RF-wireless communication capability to connect to the mobile phone base station of internet. An embodiment, the voice agent 22 of the inventive mobile phone revealed in the second embodiment of FIG. 2 can be placed inside a tablet computer so that the short-distance RF-wireless capability and the long-distance RF-wireless capability of the voice agent 22 may provide the short-distance RF-wireless capability and the long-distance RF-wireless capability to the tablet computer and the battery of the tablet computer may be the second battery 223 of the voice agent 22. Or, another embodiment, an inventive tablet computer is revealed to have the voice agent 22 of the inventive mobile phone revealed in the second embodiment of FIG. 2 and the battery of the tablet computer may be the second battery 223 of the voice agent 22.

The voice agent 22 of the inventive mobile phone revealed in the second embodiment of FIG. 2 can be wiredly or wirelessly connected to a television to provide short-distance RF-wireless capability and the long-distance RF-wireless capability to the television featuring all the information from remote mobile phone base station or internet can be displayed on the television. The wiredly connection between the voice agent 22 and the television can be hot-swap. Or, an inventive television is revealed to have the voice agent 22 of the inventive mobile phone revealed in the second embodiment of FIG. 2.

A mobile phone such as smartphone is well known to be equipped with short-distance RF-wireless communication capability such as bluetooth to communicate with other local bluetooth devices and long-distance RF-wireless communication capability to connect to the mobile phone base station or internet. An embodiment, the voice agent 22 of the inventive mobile phone revealed in the second embodiment of FIG. 2 can be placed inside a smartphone so that the short-distance RF-wireless capability and the long-distance RF-wireless capability of the voice agent 22 may provide the short-distance RF-wireless capability and the long-distance RF-wireless capability to the smartphone and the battery of the smartphone may be the second battery 223 of the voice agent 22. Or, another embodiment, an inventive mobile phone is revealed to have the voice agent 12 of the inventive mobile phone revealed in the second embodiment of FIG. 2 and the battery of the smartphone may be the second battery 223 of the voice agent 22. Many people are seen to carry more than one mobile phone. One of them can have the voice agent 22 of the inventive mobile phone revealed in the second embodiment of FIG. 2.

1. A mobile phone, comprising:
a handset having RF-wireless capability, a touchscreen supporting multi-touch and a first battery providing power to the handset, and
a local voice agent having RF-wireless capability to RF-wirelessly communicate with the handset and a remote mobile phone base station and a second battery providing power to the voice agent, wherein when a user talks on the handset on line the user's voice input into the handset are converted into electronic signals, the electronic signals are required to be RF-wirelessly emitted to the voice agent and the voice agent RF-wirelessly emits the electronic signals to a remote mobile phone base station or internet, the RF-wireless emission of the electronic signal by the handset to the voice agent is a short-distance emission producing relatively low RF radiation such that when the voice agent is separated from the handset the handset is brought close to user's ear with the voice agent kept a safe distance from user's head to perform a safe talk.

2. The mobile phone of claim 1, wherein the RF-wireless communication between the handset and the remote mobile phone base station or internet has to go through the voice agent.

3. The mobile phone of claim 1, wherein the handset is capable of RF-wirelessly communicating with the remote mobile phone base station or internet.

4. The mobile phone of claim 2, wherein the handset has no telecom module unable to RF-wirelessly communicate with a remote mobile phone base station or internet, the handset is a smartphone or a remote controller to control a television.

5. The mobile phone of claim 1, the voice agent wiredly or wirelessly connects to public switched telephone network (PSTN) to become an internet, GSM and PSTN integration center.

6. The mobile phone of claim 1, wherein the RF-wireless communication between the handset and the local voice agent is bluetooth, NFC, or IEEE 802.11 standard and the RF-wireless communication between the local voice agent and the remote mobile phone base station or internet is 2G, GSM, 3G, 4G, LTE, Wimax or Wi-Fi standard.

7. The mobile phone of claim 2, wherein the RF-wireless communication between the handset and the voice agent is bluetooth, NFC, or IEEE 802.11 standard and the RF-wireless communication between the voice agent and the remote mobile phone base station or internet is 2G, GSM, 3G, 4G, LTE, Wimax or Wi-Fi standard.

8. The mobile phone of claim 3, wherein the RF-wireless communication between the handset and the voice agent is bluetooth, NFC, or IEEE 802.11 standard and the RF-wireless communication between the handset and the remote mobile phone base station or internet is 2G, GSM, 3G, 4G, LTE, Wimax or Wi-Fi standard.

9. The mobile phone of claim 4, wherein the RF-wireless communication between the handset and the voice agent is bluetooth, NFC, or IEEE 802.11 standard and the RF-wireless communication between the voice agent and the remote mobile phone base station or internet is 2G, GSM, 3G, 4G, LTE, Wimax or Wi-Fi standard.

10. The mobile phone of claim 5, wherein the RF-wireless communication between the handset and the voice agent is bluetooth, NFC, or IEEE 802.11 standard and the RF-wireless communication between the voice agent and the remote mobile phone base station or internet is 2G, GSM, 3G, 4G, LTE, Wimax or Wi-Fi standard.

11. The mobile phone of claim 1, wherein the voice agent is placed in a portable power bank, a camera, a tablet computer, a smartphone, a wearable watch or a home intelligence appliance controlled center.

12. The mobile phone of claim 4, wherein the voice agent is placed in a portable power bank, a camera, a tablet computer, a smartphone, a wearable watch or a home intelligence appliance controlled center.

13. The mobile phone of claim 5, wherein the voice agent is placed in a portable power bank, a camera, a tablet computer, a smartphone, a wearable watch or a home intelligence appliance controlled center.

14. The mobile phone of claim 6, wherein the voice agent is placed in a portable power bank, a camera, a tablet computer, a smartphone, a wearable watch or a home intelligence appliance controlled center.

15. The mobile phone of claim 9, wherein the voice agent is placed in a portable power bank, a camera, a tablet computer, a smartphone, a wearable watch or a home intelligence appliance controlled center.

16. The mobile phone of claim 10, wherein the voice agent is placed in a portable power bank, a camera, a tablet computer, a smartphone, a wearable watch or a home intelligence appliance controlled center.

17. The mobile phone of claim 9, wherein the voice agent is separably connected to the handset for easy carrying and the connection is separable.

18. The mobile phone of claim 9, wherein the voice agent is contained inside the handset.

19. The mobile phone of claim 9, wherein the voice agent and the handset respectively further comprise a first connector and a second connector, the voice agent is separably connected to the handset causing the electrical connection between the first connector and the second connector, the handset and the voice agent are in electrically wired communication by the electrical connection between the first connector and the second connector and the RF-wireless communication between the handset and the voice agent is disabled by the electrical connection between the first connector and the second connector and when the first connector and the second connector are electrically separated the RF-wireless communication between the handset and the voice agent is restored by the electrical separation between the first connector and the second connector.

20. The mobile phone of claim 9, wherein the voice agent and the handset respectively further comprise a first connector and a second connector, the voice agent is separably connected to the handset causing the electrical connection between the first connector and the second connector, when the first battery is electrically charged the second battery is electrically charged at the same time by the electrical connection between the first connector and the second connector.
